(19) United States
(12) Patent Application Publication
(10) Pub. No.: US 2010/0070128 A1
(43) Pub. Date: Mar. 18, 2010

(54) VEHICLE OPERATION BY LEVERAGING TRAFFIC RELATED DATA

(75) Inventor: Michael S. B. Johnson, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/210,456

(22) Filed: Sep. 15, 2008

(51) Int. Cl. G08G 1/00

(52) U.S. Cl. 701/33; 701/117; 701/103

(57) ABSTRACT

A platform is provided for receiving traffic related data collected from a network of sensors and forwarding traffic related data to on-vehicle technologies. The on-vehicle technologies include hardware and software components and are configured to enable motorists to make informed decisions on operation of their vehicles regarding fuel economy and road safety. The on-vehicle technologies may also be enabled to automatically adjust vehicle operation parameters such as automatic turning off and on of the engine at a stop light based on traffic related data received from the platform.

### BACKGROUND

Motorists idle their vehicle engines at stoplights so they are able to immediately move when the light turns green, and/or to heat the vehicle, power vehicle accessories or charge the vehicle's battery. This idling consumes increasingly expensive fuel and pollutes.

Another aspect of motor vehicle traffic associated with intersections and traffic lights is road safety. Some motorists endanger themselves and others when they respond to traffic congestion by pushing or running stoplights and/or erratically changing speed or direction to avoid stopping at intersections. With traffic congestion on the rise, these behaviors are likely to become more frequent too.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing motorists with information regarding intersections on their travel route, thus enabling them to make informed decisions and operate their vehicles in a fashion that improves vehicle operation, for example increases fuel economy (e.g., reduces consumption of fuel or otherwise conserves energy) and/or road safety. Other embodiments automatically adjust vehicle operation, for example by automatically turning the vehicle engine off and on based on expected timing of traffic lights at an intersection.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating top level components of a system for providing motorists with information related to traffic conditions at intersections on their route;

FIG. 2 illustrates example scenarios where a system according to embodiments may be beneficial to a motorist;

FIG. 3 is a block diagram illustrating main components of a platform for providing on-vehicle technologies with information related to traffic conditions at intersections on a motorist's route;

FIG. 4 is a conceptual diagram illustrating example hardware environments for on-vehicle technologies consuming data from a platform such as one shown in FIG. 3 and example outputs of such applications;

FIG. 5 is an example networked environment, where embodiments may be implemented;

FIG. 6 is a block diagram of an example computing operating environment, where a platform according to embodiments may be implemented;

FIG. 7 is a block diagram of an example computing operating environment, where an on-vehicle technology according to embodiments may be implemented;

FIG. 8 illustrates a logic flow diagram for processing collected traffic-related data at a platform according to embodiments; and

FIG. 9 illustrates a logic flow diagram for an operation of an example on-vehicle technology consuming data received from a platform according to embodiments.

### DETAILED DESCRIPTION

As briefly described above, motorists may be provided information associated with intersections on their route through on-vehicle technologies enabling them to make informed decisions on operation of their vehicles regarding fuel economy and road safety. The applications may also be configured to automatically adjust vehicle operation parameters such as automatically turning off and on of the engine based on expected timing of traffic lights at an intersection. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “on-vehicle technology” refers to a combination of hardware and software configured to perform predefined tasks based on traffic-related information. While the term “on-vehicle” may be understood as specific to vehicles, such technologies are not restricted to vehicle computers or other computing devices installed on vehicles. According to some embodiments, such technologies may include programs stored and executed on a portable device such as a smart phone, handheld computer, and similar devices while the device is on or in a vehicle in such a way that it can perform the predefined tasks associated with vehicle operation. A “platform” as used herein may be a combination of software and hardware components for managing traffic related data. Examples of platforms include, but are not limited to, a hosted service executed over a plurality of servers, an application executed on a single server, and comparable systems. The term “server” refers to a computing device executing one or more software programs typically in a networked environment. More detail on these technologies and example operations is provided below.

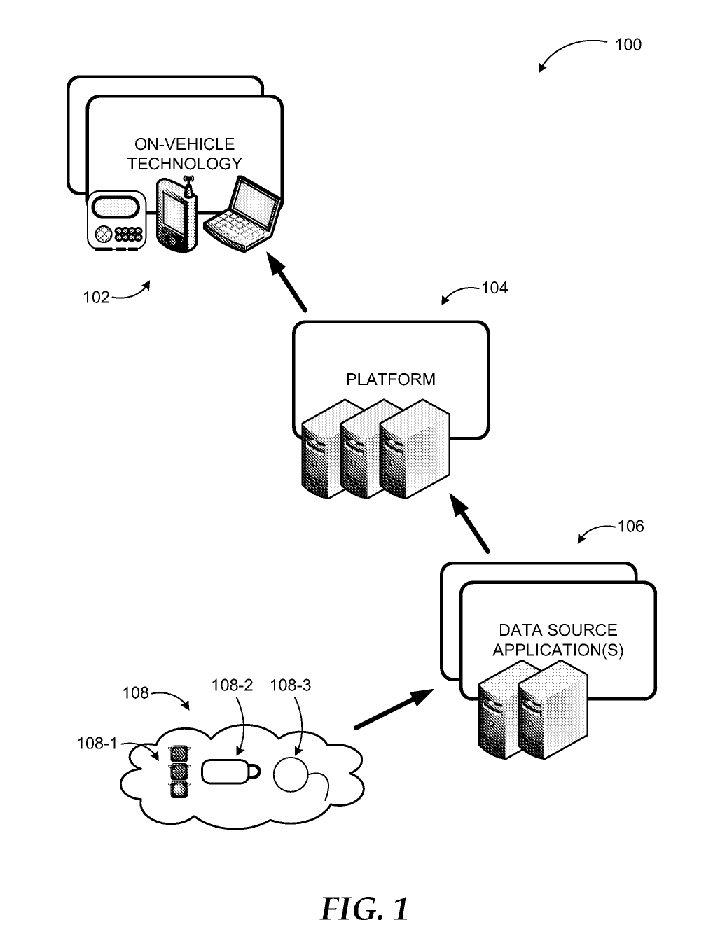

Referring to FIG. 1, conceptual diagram 100 illustrates top level components of a system for providing motorists with information related to traffic conditions at intersections on their route. By providing motorists with information associated with intersections on their route, they may be enabled to make informed decisions on operation of their vehicles regarding fuel economy and road safety. For example, countdown timers are installed on some traffic lights to display the number of seconds remaining before the signal is programmed to change state. Countdown timers for pedestrian signals are more common than those for vehicular traffic. This timing information (a part of the traffic signal control system) may be exposed to motorists wirelessly allowing them to react to signal timings by turning off engines at long red lights or adjusting their speed when they approach an intersection and know the light will turn red soon (preferably slowing down). This way, pollution and fuel consumption may be reduced, and potentially dangerous driving behavior may be avoided. An example of potentially dangerous driving behavior includes running a red light (intentionally or accidentally).

Another type of information relating to intersections that can be collected is the presence of vehicles and pedestrians at the intersection (especially when the light is red). Information regarding the speed of approaching vehicles can also be collected. Optical sensors such as cameras and in-road loop antennas are typically used to collect this information, but other types of sensors may also be implemented, for example mechanisms that use radar, lasers and comparable mechanisms to collect this information. Thus, information associated with traffic signal timing and/or road hazards at intersections may be collected from a network of sensors 108 by data source application(s) 106. The network of sensors 108 may comprise a number of data collection sensors including, but not limited to, traffic light timing controllers 108-1, optical sensors 108-2, in-road loop antennas 108-3, and similar mechanisms as discussed above. In example embodiments, a municipality can manage the data source application(s) 106 and make the collected data available to third parties.

According to one embodiment, a platform 104, which may be executed as a hosted service over a plurality of servers, may receive the collected traffic related data from data source application(s) 106, analyze it, and make it available to consuming applications 102 on vehicles. The traffic related data (e.g. traffic signal timing, vehicle or pedestrian presence on any given road approaching an intersection, and similar information) may be analyzed to determine what it means for a motorist. For example, a vehicle detected to be accelerating as it approaches a red light is significant for road safety applications that may alert the motorist on a cross street approaching the same intersection. The analysis may employ one or more algorithms such as a branch-and-bound algorithm, a progressive improvement algorithm, or a heuristic algorithm to interpret and filter the data, and to determine significance for the motorist. On-vehicle technologies 102 may include one or more applications executed on vehicle computers or other portable devices associated with the vehicle such as a smart phone in a cradle in the vehicle. This way, a device executing such applications need not be permanently attached to the vehicle, and the device may continue to be useful for consuming and analyzing traffic data while disconnected from the vehicle.

On-vehicle technologies 102 can also be used by other travelers such as pedestrians and cyclists, for example to become aware of and respond to traffic-related situations that can affect their safety. In addition, vehicles as considered herein can include vehicles powered by one or more motors and one or more power sources. Example motors include internal combustion engines, external combustion engines, electric motors, turbines, and other motors. Example power sources include combustible fuel, fuel cells, batteries, solar cells, connections to external power sources such as electric lines or rails, and other power sources.

The on-vehicle technologies 102 may perform tasks such as automatic shut-off of the engine while waiting at a red light. If the vehicle does not support automatic engine shut-off, it could still provide an audio or visible signal to the driver to recommend when the engine should be shut off and restarted manually based on the stop light timing data. Moreover, a motorist approaching a traffic signal may be advised by the vehicle's computer what speed would be optimal for arriving when the light will turn green. Such advice may help the motorist to minimize the wait at traffic signals or to even avoid coming to a complete stop whenever it is safe and possible to do so.

A visual, audible, tactile, and/or similar reminder inside the vehicle may remind a stopped or moving motorist to return his/her attention from some distraction (e.g. making a phone call, drinking a beverage, talking with passengers, tending to children, looking for something in the glove compartment) back to traffic with sufficient time to prepare for an event such as resuming motion, or encountering an intersection or a pocket of congestion. Motorists may also be warned when it is futile (and illegal) to increase speed to beat the light about to turn red.

With the help of a Global Positioning Service (GPS) system or other location system that indicates a location of the user's vehicle, a recommended route may be adjusted based not only on static map data or even up-to-date construction and congestion data, but also on up-to-the-second timing information from multiple traffic signals along the route.

As described above, a system according to embodiments may warn a motorist about his or her own inattention or irresponsible behavior, which could pose a threat to other people or vehicular traffic. The system may also warn a motorist about external threats when the motorist is operating a vehicle safely at an intersection, whether or not the motorist is in motion. For example, on-vehicle technologies may alert motorists against pedestrians or vehicles that may cross the motorist's path at the intersection when the motorist has a green light. Other hazards these technologies may caution motorists against include other vehicles approaching the intersection at high speed or engaged in other dangerous driving behavior, weather and/or road conditions such as icing, road constructions, and comparable hazards. Moreover, motorists may be alerted about emergency vehicles approaching them from any direction.

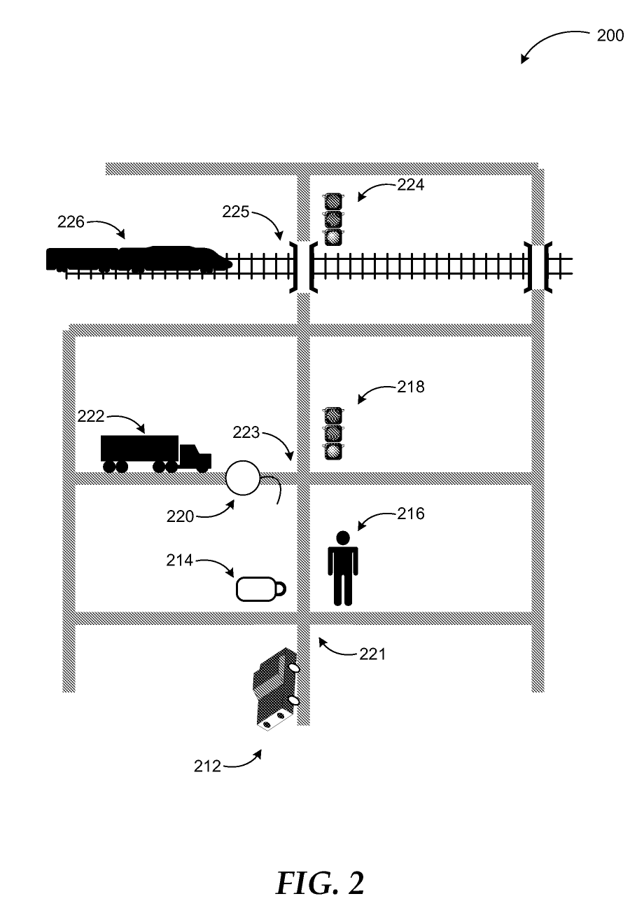

FIG. 2 illustrates example scenarios where a system according to embodiments may be beneficial to a motorist. Map 200 shows vehicle 212 traveling on a road approaching a first intersection 221 with optical sensor 214. If the optical sensor 214 detects the presence of a pedestrian 216 in the intersection despite the light being green to vehicle 212, the data may be transmitted through the platform 104 to the on-vehicle technology 102 that can then alert the motorist about the presence of the pedestrian such that the motorist may slow down as he/she approaches the intersection.

At the following intersection 223 featuring a traffic light 218, an in-road loop antenna 220 may detect an approaching truck 222 and alert the motorist similarly. In addition, timing data associated with traffic light 218 may also be forwarded to the on-vehicle technology enabling the motorist to adjust his/her speed while approaching the intersection or turn off the engine while waiting at a prolonged red light (expected to last longer than a predefined threshold such as 30 second, one minute, etc.).

The alert or recommended action to the motorist may also be based on a combination of factors such as speed and distances of detected vehicles at an intersection, braking capability of the motorist's vehicle (for example, braking capabilities of trucks may differ significantly from automobiles), braking capability of detected vehicles, and similar factors.

Information about trains (226) approaching railroad intersections (e.g. 225) may be provided to on-vehicle technologies from a central information system of the railroad along with traffic light timing information (224) for the on-vehicle technology to perform its tasks. One of those tasks may include analyzing road hazard (e.g. other vehicles engaged in dangerous driving behavior such as approaching the intersection at high speed, weather and/or road conditions such as icing, road constructions, and comparable hazards) and traffic signal timing information on the selected route for the vehicle and providing a report to the motorist along with recommendations for alternative routes. The alternative routes may be computed using one or more of a branch-and-bound algorithm, a progressive improvement algorithm, a heuristic algorithm, or another algorithm.

A system according to embodiments may receive traffic related data from a number of sources in addition to sensors associated with intersections and railway crossings. For example, such a system may interact with other vehicle or transportation systems including: light rail systems (e.g. trams, street cars); ferry boats (which could announce their schedules and capacity); draw bridges (bridges that are sometimes closed to traffic); toll gates or toll plazas; traffic metering gates or signals; emergency vehicles (which would not only be able to request that normal traffic pull over long before their sirens are even in audible range, but would be able to pick a route based on the density of traffic reported by the traffic system); construction vehicles (which could warn nearby traffic of their intent to enter, block, or leave the road); and others. Furthermore, a system according to embodiments may also be implemented for not only motor vehicles on public roads (automobiles, motorcycles, bicycles, and similar vehicles), but also for any of the above described vehicle systems.

A platform as described herein may also interact with other systems for receiving and/or providing data such as financial systems, which may allow cashless electronic payments between an individual and a business (such as a drive-through/drive-in restaurant, drive-through bank, drive-through pharmacy, drive-in movie theater, or parking lot), or between an individual and a government (such as at a toll booth, highway weighing station, state park entrance, or in response to a traffic infraction such as an uncontested speeding ticket). Other systems that may interact with a platform according to one embodiment may include law enforcement systems for querying the vehicle's driving record to verify an alibi or its registration status without having to look for stickers on a license plate, or for locating a stolen vehicle; advertising providers, which may wish to deliver targeted advertising to consumers based on specific publicly exposed data about the vehicle, its occupants, or route; and telephony systems, which may provide hands-free two-way telephone communication with any phone number, multi-party communication among vehicles, and similar communication mechanisms.

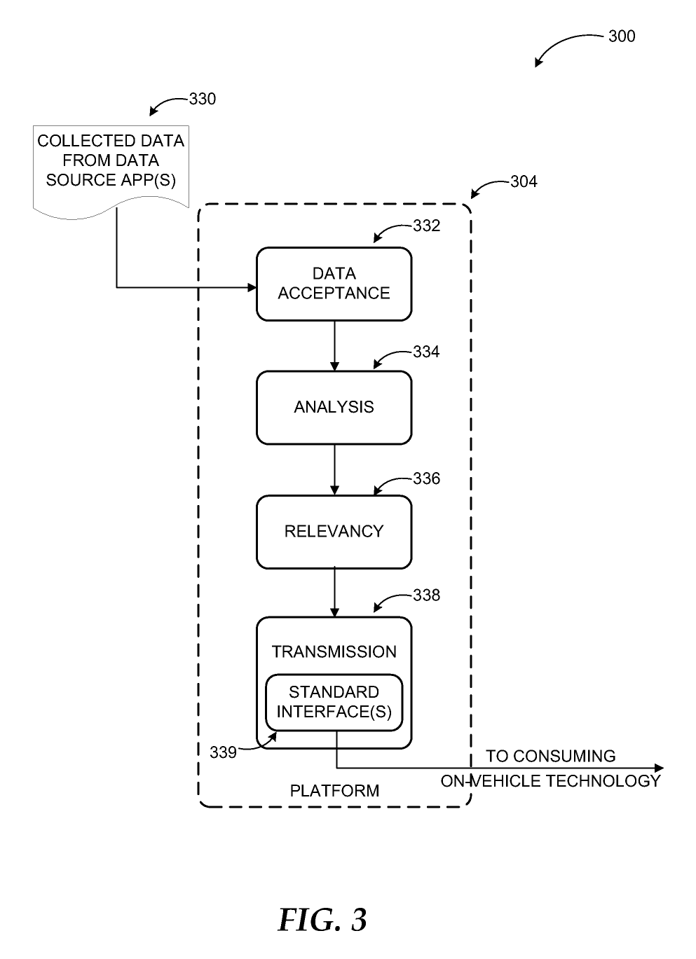

FIG. 3 includes block diagram 300 illustrating main components of a platform for providing on-vehicle technologies with information related to traffic conditions at intersections on a motorist's route. Traffic related data collected from sensors and controllers throughout a defined area may be provided by one or more data source applications to a data acceptance module 332 of platform 304. Data acceptance module 332 may perform operations such as validation, formatting, and pre-processing of the received data. The data may then be analyzed in an analysis module 334 to determine information that may be useful or relevant to a motorist. As discussed above, the analysis may include or employ a number of algorithms such as a branch-and-bound algorithm, a progressive improvement algorithm, or a heuristic algorithm to interpret and filter the data, and to determine significance for the motorist. Some or all of the analyzed data may be stored. Relevancy module 336 may determine a relevant portion of the analyzed data for particular on-vehicle technologies. Even in a medium size municipality the number of data collection points and the amount of collected road data may be significant and cumbersome to transmit to all on-vehicle technologies. Therefore, a relevant portion of the data based on location and route of the vehicle may be determined and subsequently transmitted to the on-vehicle technologies through transmission module 338 using a variety of communication means. Transmission module 338 may also include standard interface(s) 339 for communication with on-vehicle technologies using standard or proprietary communication protocols.

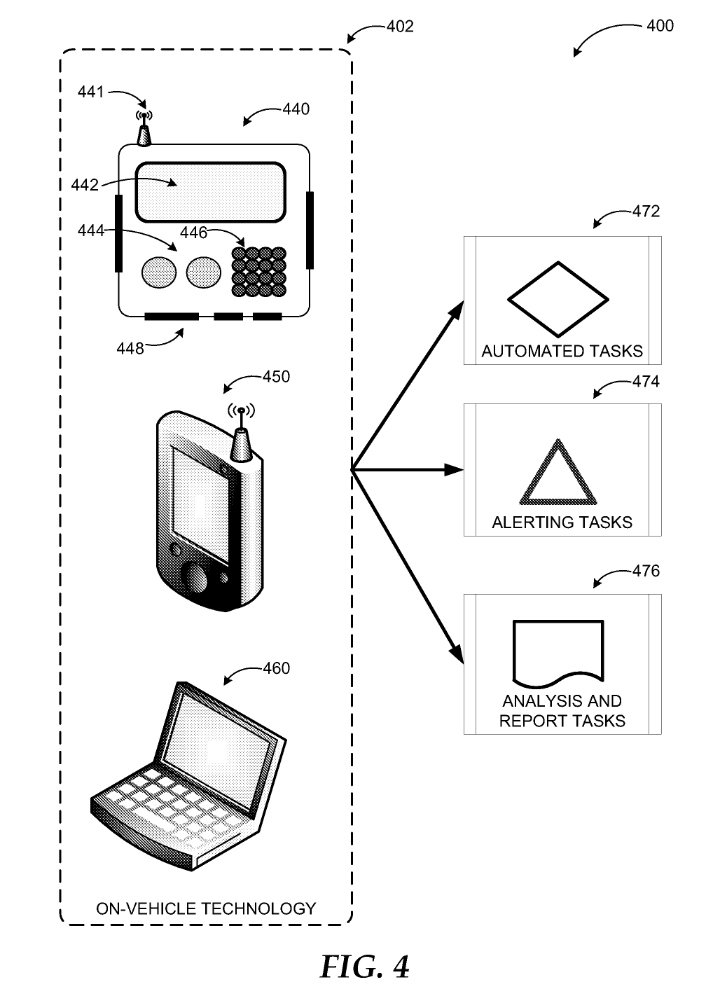

FIG. 4 is a conceptual diagram illustrating example hardware environments for on-vehicle technologies consuming data from a platform such as one shown in FIG. 3 and example outputs of such technologies. As mentioned previously, on-vehicle technologies 402 may be any combination of computer program(s) and relevant hardware that can perform vehicle operation related tasks based on received data from the platform. In an example embodiment, on-vehicle technology 402 may be embodied as one or more applications executed on a vehicle mount computer such as a smart automobile console, but other portable devices can be used to provide a suitable hardware environment for executing the applications. Other example devices include a laptop 460 or a smart phone 450. When the portable device that is the hardware component of on-vehicle technology 402 is connected to a car computer or is switched into an in-vehicle operation mode by the user (e.g. by selection of the in-vehicle operation mode on the portable device), relevant application(s) may be executed to receive traffic related data and perform below discussed tasks.

A vehicle mount computer 440 with its Radio Frequency (RF) communication antenna 441, display 442, control knobs 444, keys 446, and wired communication interfaces 448 may execute one or more applications as part of the on-vehicle technology. While a single application may be used to perform one or more vehicle operation related tasks, multiple applications may also be executed for individual tasks.

Moreover, an on-vehicle technology may operate in conjunction with other (auxiliary) software applications operating on the same hardware environment or on another device. For example, location information for the vehicle may be received from an on-board GPS device. A cellular phone may be used to communicate with the platform to receive traffic related data and then provide it to the on-vehicle technology. Other auxiliary applications may include a mapping application, a fuel consumption monitoring application, and a traffic condition display application.

Vehicle operation related tasks that may be performed by the on-vehicle technologies 402 include automated tasks 472 that may be performed without motorist intervention. For example, is a car comes to a stop at an intersection waiting for a red light and the on-vehicle technology determines from received traffic light timing data that it would be more fuel efficient to turn the engine off, the application may turn off the engine automatically. Another example may be adjustment of fuel consumption parameters such as fuel injection settings based on expected speed when approaching an intersection based on received traffic light data at that intersection. If the vehicle is approaching an intersection, where the traffic light is expected to turn red, engine braking may be applied to reduce fuel consumption and ensure a safe stop. Other automated tasks may include switching on or off of turn signals, brake lights when engine braking is used (as opposed to braking via a system that is substantially independent from the vehicle's engine, for example via hydraulically actuated disc or drum brakes), and similar mechanisms. In an embodiment, the vehicle includes a regenerative braking system and the application can automatically actuate the regenerative braking system to both slow the vehicle and recapture kinetic energy of the vehicle, for example by converting it into electrical energy and storing the converted energy.

Of course a safety override mechanism may be provided to the motorist to take over control of vehicle operation if any of these automated tasks may endanger the vehicle and its occupants. For example, a first vehicle may begin to slow down when approaching an intersection with the anticipation of red light, but a second vehicle may be approaching the first vehicle at high speed from behind. Realizing that, the motorist in the first vehicle may override the automated controls and speed up or get out of the way of the second vehicle. In addition, the on-vehicle technology can recommend a reduced speed and/or automatically adjust fuel injection settings to take advantage of situations where a reduced speed will conserve energy by allowing the vehicle to maintain speed and avoid braking. For example, the on-vehicle technology can reduce the vehicle's speed so that the vehicle reaches an intersection later when a light is green instead of earlier while it is red, thereby smoothing traffic flow and reducing energy that may be lost by braking.

Another category of tasks includes alert tasks 474 for providing alerts to motorists. In the example above, the on-vehicle technology may provide an audio, tactile and/or visual alert to the motorist to turn off the engine instead of turning off the engine automatically. The alert function may be even more useful in tasks related to road safety. For example, the data collection system may detect a vehicle or a pedestrian that is running a red light or is about to run a red light (based on camera sensor or in-road loop antenna sensing). Upon receiving data about this detection, the on-vehicle technology may issue the alert to the motorist in the vehicle approaching the intersection possibly preventing an accident.

Yet another category of tasks performed by on-vehicle technologies may include analysis and report tasks 476 for analyzing road conditions and reporting based on the analysis. For example, an on-vehicle technology may receive traffic light timing data for alternative routes and determine expected travel time and/or fuel consumption for the alternate routes and then provide the motorist the information for the alternate routes. Similarly, the on-vehicle technology may analyze road hazard data (number of vehicles running or approaching fast red lights along a selected route) and provide an assessment of alternate routes based on the road hazard data analysis.

The computing devices executing on-vehicle technologies may communicate with the platform 104, 304 via Wireless Local Area Network (WLAN) communications, Wide Area Network (WAN) communications, cellular network communications, and comparable communication systems. The communication may be over open or secure networks and include user authentication based on user profiles.

While specific computing devices and vehicle operation related tasks have been described above, these are for illustration purposes only and do not constitute a limitation on embodiments. Many other hardware environments and vehicle operation related tasks may be implemented using the principles described herein.

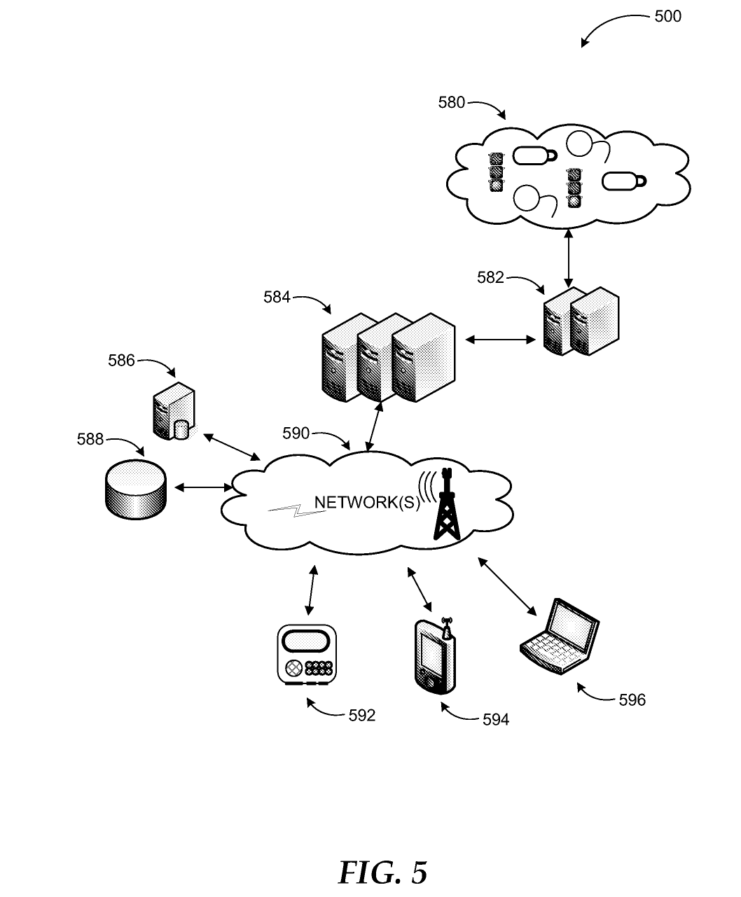

FIG. 5 is an example networked environment, where embodiments may be implemented. Data source application(s) may be executed on one or more servers 582 and collect data from a network of sensors (580) at road intersections such as timing controllers of traffic lights, in-road loop antennas, camera sensors, and similar sensors. The data source application(s) may be part of a service managed and provided by a municipality.

A platform providing traffic related data to consuming on-vehicle technologies may be implemented via software executed over one or more servers 584 such as a hosted service and receive the collected data from data source application(s) on servers 582. The platform may communicate with consuming applications on individual portable or vehicle-mount devices such as a smart automobile console 592, a smart phone 594, or even a laptop computer 596 through network(s) 590.

Network(s) 590 may facilitate a number of devices and applications implemented in un-clustered systems or clustered systems to provide traffic related data to on-vehicle technologies. Such a system may comprise any topology of servers, clients, Internet service providers, and communication media. Also, the system may have a static or dynamic topology. Network(s) 590 may include a secure network such as an enterprise network, an unsecure network such as a wireless open network, or the Internet. Network(s) 590 provide communication between the nodes described herein. By way of example, and not limitation, network(s) 590 may include wireless media such as acoustic, RF, infrared and other wireless media. The platform may also communicate with data storage facilities such as data store 588 and database server 586 to store traffic related data, on-vehicle technology configurations, user profiles, and other related data.

Many other configurations of computing devices, applications, data sources, and data distribution systems may be employed to implement a system for improving fuel economy and road safety by leveraging traffic related data. Furthermore, the networked environments discussed in FIG. 5 are for illustration purposes only. Embodiments are not limited to the example applications, modules, or processes.

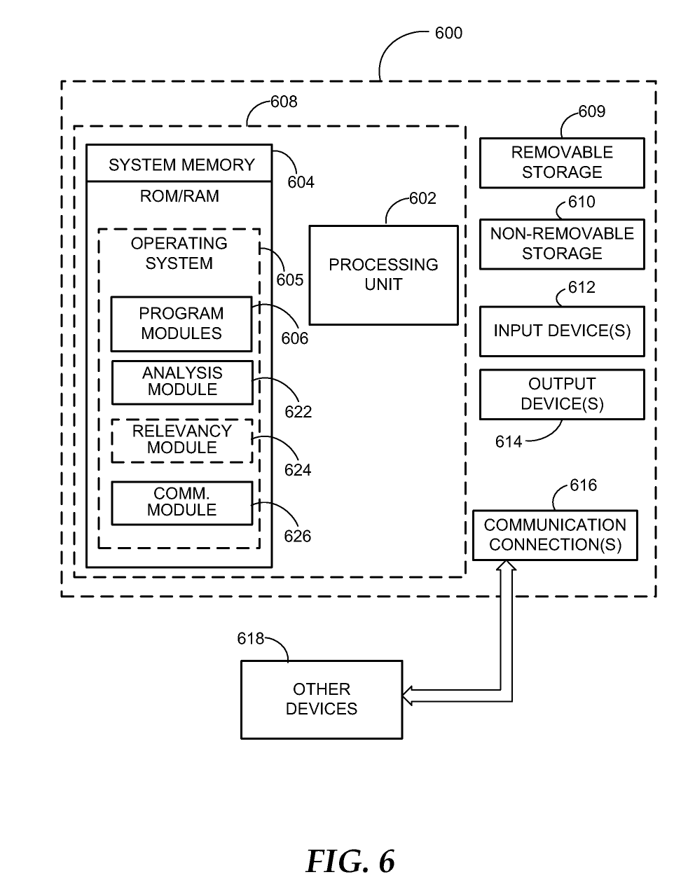

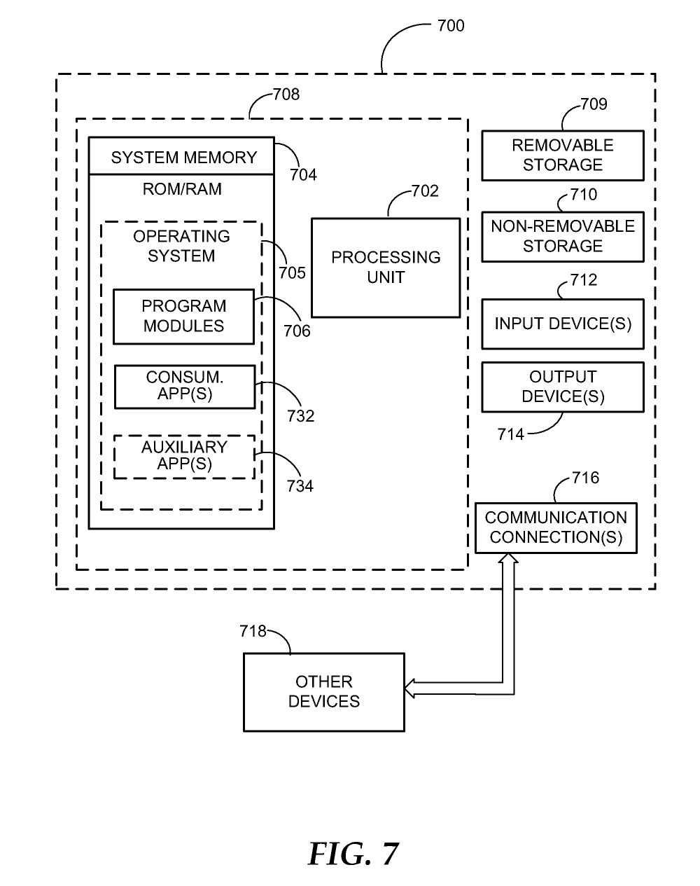

FIG. 6-7 and the associated discussion are intended to provide a brief, general description of a suitable computing environment in which embodiments may be implemented. With reference to FIG. 6, a block diagram of an example computing operating environment for a platform according to embodiments is illustrated, such as server 600. A platform according to embodiments may be executed as a hosted application over a plurality of servers or on a single server. In a basic configuration, server 600 may include at least one processing unit 602 and system memory 604. Server 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, analysis module 622, optional relevance module 624, and communication module 626.

Analysis module 622, optional relevance module 624, and communication module 626 may be separate applications or integral modules of a hosted service that provides traffic related services to client applications/devices. Analysis module 624 may analyze data received from one or more data source applications. As discussed below in more detail, optional relevancy module 624 may determine a relevant portion of the analyzed data for particular on-vehicle technologies before the data is provided to those on-vehicle technologies. Communication module 626 may operate in conjunction with communication connections component 616 of server 600 and facilitate receipt of data from data source applications and transmission of relevant portions of data to receiving on-vehicle technologies. As such, communication module 626 may implement communication protocols, select among available communication means (e.g. WAN, cellular, and similar communication means), and perform filtering and other processing of data to be transmitted. This basic configuration is illustrated in FIG. 6 by those components within dashed line 608.

Server 600 may have additional features or functionality. For example, the server 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by server 600. Any such computer readable storage media may be part of server 600. Server 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Server 600 may also contain communication connections 616 that allow the device to communicate with other devices 618, such as over a wireless network in a distributed computing environment, a satellite link, a cellular link, and comparable mechanisms. Other devices 618 may include server(s) that execute applications associated with a collecting traffic related data, GPS satellites providing GPS data, cellular towers providing external data and/or positioning data, and portable computing devices executing applications that consume the analyzed data from the platform. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

FIG. 7 illustrates a block diagram of an example computing operating environment, where an on-vehicle technology according to embodiments may be implemented. Computing device 700 for executing application(s) associated with the on-vehicle technology may be any portable vehicle mount computing device such as a smart automobile console, a handheld computer, a smart phone, and similar devices.

Standard components of computing device 700 such as processing unit(s) 702, removable storage 709, non-removable storage 710, input devices 712, output devices 714, communication connections 716, and system memory 704 are similar to likewise numbered components of server 600 of FIG. 6, and are not discussed in further detail here. It should be noted, however, that in an example embodiment the computing device 700 is a portable or vehicle mount device, and some or all of those standard components may be configured according to the portable/vehicle mount characteristics of the computing device 700. For example, processing unit(s) 702 may include mobile device processors. Operating system 705 is for controlling the operation of one or more on-vehicle technologies, such as the WINDOWS MOBILE® operating systems from MICROSOFT CORPORATION of Redmond, Wash. The system memory 704 may include in addition to one or more program modules 706, consuming application(s) 732, and auxiliary application(s) 734.

Consuming application(s) 732 are any application executed on an on-vehicle computing device such as a smart automobile console or a portable device such as a smart phone when used in a vehicle. If executed on a non-vehicle computing device, the application may be made aware of the vehicle use by user input or through connection to the vehicle computer as described previously. Upon receiving relevant portion of analyzed road data from the platform, the consuming application(s) 732 perform tasks related to vehicle operation as discussed previously. Consuming application(s) 732 may perform their tasks in conjunction with auxiliary application(s) 734. For example, a consuming application may receive location data from a GPS device/application in addition to the data received from the platform. Another example of using an auxiliary application is receiving complementary traffic related data from a digital radio service. A further example includes use of a cellular phone for communication purposes with the platform by the consuming application.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

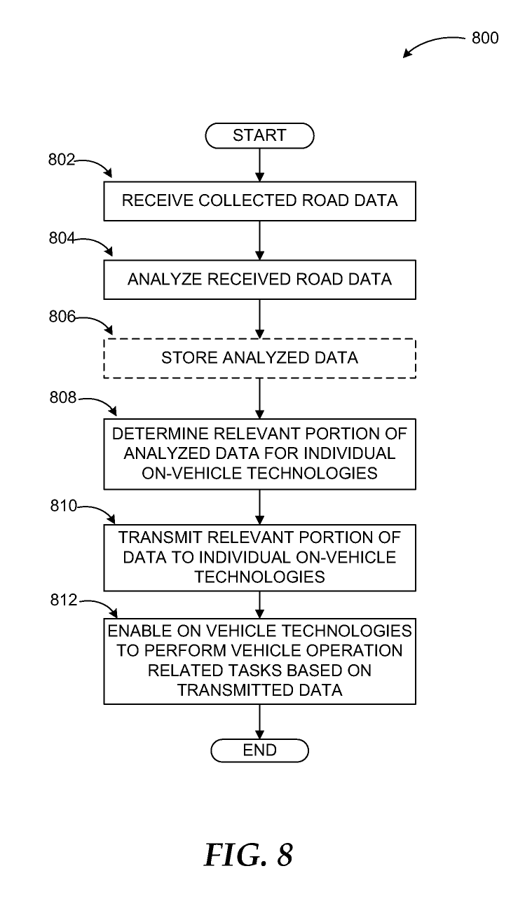

FIG. 8 illustrates a logic flow diagram 800 for processing collected traffic-related data at a platform according to embodiments. Process 800 may be implemented as part of a traffic based motorist information platform executed in one or more servers such as the one described above in conjunction with FIG. 3.

Process 800 begins with operation 802, where collected road data is received from one or more data source applications. As discussed previously, such applications may be part of a municipality owned network and collect data from a variety of sensors and controllers at intersections and other locations. This traffic related data may include information associated with an intersection such as traffic signaling status information, traffic signaling timing information, vehicle presence information, pedestrian presence information, or possible vehicle presence information. Vehicle presence information includes information about vehicles whose presence is detected through sensors at an intersection, while possible vehicle presence information includes information about detected vehicles approaching an intersection based on their distance, speed, and similar parameters. Processing advances from operation 802 to operation 804.

At operation 804, the received road data is analyzed. According to some embodiments, raw data (e.g. traffic signal timing, vehicle or pedestrian presence on any given road approaching an intersection, and similar information) may be received from the data source applications and this data may need to be interpreted as to what it means for on-vehicle technologies. For example, data indicating a vehicle slowing down as it reaches a red light detected by a loop antenna (or camera) sensor may not have significance for any on-vehicle technologies associated with the platform. On the other hand, a vehicle detected to be accelerating as it approaches a red light is significant for road safety applications that may alert a motorist on a cross street approaching the same intersection. Therefore, the platform may interpret, filter, and analyze the data to determine significance, format for communication with associated on-vehicle technologies, and perform other tasks such as compression. Processing moves from operation 804 to optional operation 806.

At optional operation 806, the analyzed data may be stored. While most of the data discussed herein may be useful for a brief time period, analyzed data may need to be stored for purposes such as long term traffic pattern analysis. Processing advances from optional operation 806 to operation 808.

At operation 808, a relevant portion of the analyzed (and otherwise processed) data is determined for individual on-vehicle technologies. In any given geographical location, there may be hundreds if not thousands of intersections. Thus, the total amount of traffic related data may be quite large and impractical to transmit to each on-vehicle technology. The platform may determine based on a location and/or route of a vehicle which portion of road data is relevant for the on-vehicle technology associated with that vehicle and make that portion available to the on-vehicle technology. According to other embodiments, a human operator of the device may direct an application to perform a task that requires information beyond the immediate vicinity (for example: the user zooms a map out to display a larger area than before, requiring the application to request more data than what the platform may typically provide). Processing moves from operation 808 to optional operation 810.

At operation 810, the relevant portion of the analyzed road data is transmitted to the individual on-vehicle technologies. The data may be transmitted through various means as discussed above periodically, upon request, or upon a predefined trigger event (e.g. change in data). Processing moves from operation 810 to operation 812.

At operation 812, individual applications and hardware associated with the on-vehicle technology are enabled to perform vehicle operation related tasks based on the transmitted data. The on-vehicle technology may be enabled through receiving the data, receiving instructions transmitted along with the data, and comparable mechanisms. Examples of such tasks and how these applications and hardware may operate are discussed in more detail in conjunction with previous figures and below. After operation 812, processing moves to a calling process for further actions.

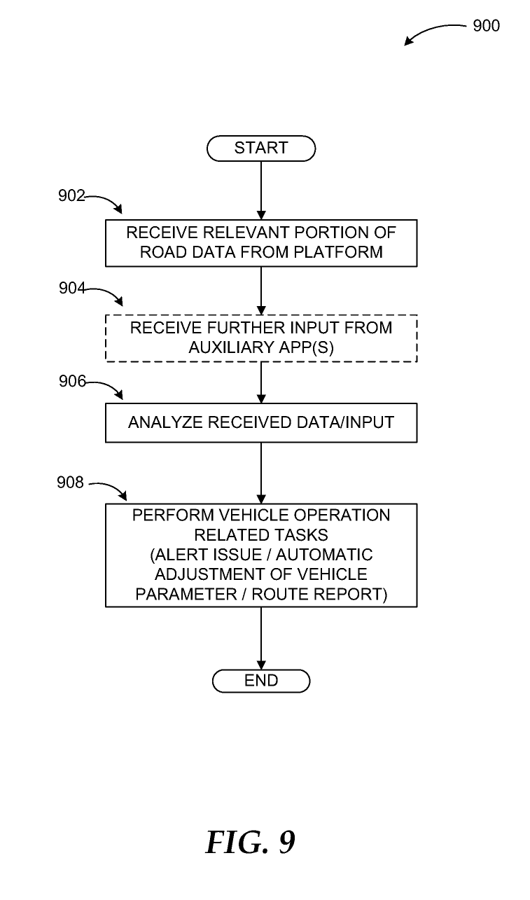

FIG. 9 illustrates a logic flow diagram 900 for an operation of an example on-vehicle technology consuming data received from a platform according to embodiments. Process 900 may be implemented in a computing device associated with a vehicle such as those described above in conjunction with FIG. 4.

Process 900 begins with operation 902, where relevant portion of analyzed road data is received from the platform as discussed above. Processing advances from operation 902 to optional operation 904, where further input from one or more auxiliary applications may be received. As mentioned earlier, an on-vehicle technology may receive data from other sources such as a GPS device/application in addition to the platform (machine sources) or through user input (human source) and perform its tasks in conjunction with other devices/applications such as communication through a connected cellular phone. Processing moves from optional operation 904 to operation 906.

At operation 906, the on-vehicle technology may analyze the received data for its purposes and further process it. The processing may include decompression, filtering, or other processes. Processing moves from operation 906 to operation 908.

At operation 908, vehicle operation related tasks such as issuing an alert to the motorist about a safety danger at an upcoming intersection or to turn off the engine due to expected red light period may be performed. Other tasks may include automatically turning off the engine, adjusting fuel efficiency, preparing a route analysis report, and comparable tasks.

The operations included in processes 800 and 900 are for illustration purposes. Improving fuel economy and road safety by leveraging traffic related data in a platform and in on-vehicle technologies may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for improving vehicle operation based on traffic related data, the method comprising:
receiving traffic related data collected from a plurality of sensors at traffic signaling locations;
analyzing the received data;
determining a relevant portion of the analyzed data for a particular on-vehicle technology; and
transmitting the relevant portion of the analyzed data to the on-vehicle technology through a wireless medium such that the on-vehicle technology is enabled to perform one of the following: adjusting a vehicle operating parameter automatically and alerting a driver of the vehicle to adjust the vehicle operating parameter manually.

2. The method of claim 1, wherein the traffic related data includes information associated with an intersection comprising one or more from a set of: traffic signaling status information, traffic signaling timing information, vehicle presence information, pedestrian presence information, and possible vehicle presence information.

3. The method of claim 1, wherein adjusting the vehicle operating parameter automatically includes at least one from a set of: shutting off engine in response to determining a prolonged red light exceeding a predefined threshold, turning on the engine at a predefined time prior to traffic signal turning green, reducing vehicle speed employing an engine brake, and adjusting a fuel injection amount.

4. The method of claim 1, wherein alerting the driver of the vehicle includes providing one or more of the following: an audio alert, a visual alert, and a tactile alert, the alerts indicating one or more from a set of: a need to turn off engine in response to an expected prolonged red light exceeding a predefined threshold, a need to turn on the engine at a predefined time prior to traffic signal turning green, a need to reduce vehicle speed in anticipation of an upcoming red light, a need to reduce the vehicle speed in anticipation of a pedestrian crossing an upcoming red light, and a need to reduce the vehicle speed in anticipation of another vehicle potentially running an upcoming red light.

5. The method of claim 1, wherein the relevant portion of the analyzed data is transmitted to the on-vehicle technology through one or more of the following: a short range wireless network, a wide area wireless network, and a cellular communication network.

6. The method of claim 1, further comprising:
enabling the on-vehicle technology to perform its tasks based on additional data received from an auxiliary data source.

7. The method of claim 6, wherein the auxiliary data source includes at least one application from a set consisting of: a Global Positioning Service (GPS) application, a cellular communication application, and a digital traffic radio application.

8. The method of claim 1, further comprising:
receiving a start location and a destination location for the vehicle;
computing recommended routes based on fuel economy and road hazards between the start location and the destination location; and
enabling the on-vehicle technology to provide a report to the driver on the recommended routes.

9. The method of claim 8, wherein the relevant portion of the analyzed data is also determined based on the received start and destination locations.

10. The method of claim 8, wherein the recommended alternate routes are computed employing one of: a branch-and-bound algorithm, a progressive improvement algorithm, and a heuristic algorithm.

11. A system for improving vehicle operation based on traffic related data, the system comprising:
a server and an information management framework, the server configured to execute the information management framework and further configured to:
receive traffic signaling status, traffic timing, and intersection status information associated with a plurality of intersections from at least one data source application;
analyze the received information;
determine a relevant portion of the analyzed information for a subscribing on-vehicle technology;
report the relevant portion of the analyzed information to the subscribing on-vehicle technology through one or more of the following: a short range wireless network, a wide area wireless network, and a cellular communication network; and
the subscribing on-vehicle technology configured to:
receive the relevant portion of the analyzed information;
determine a vehicle operating parameter associated with fuel economy and road safety; and
perform one or more of the following: adjust the vehicle operating parameter automatically and alert a driver of the vehicle to adjust the vehicle operating parameter manually.

12. The system of claim 11, wherein the subscribing on-vehicle technology includes at least one application executed on one of the following: a vehicle-mount computing device and a portable computing device.

13. The system of claim 12, wherein the subscribing on-vehicle technology is configured to detect vehicle operation through one of the following: coupling to an on-vehicle computer and receiving a user indication of in-vehicle use.

14. The system of claim 11, wherein adjustment of the vehicle operating parameter automatically and alerting the driver of the vehicle to adjust the vehicle operating parameter manually is based on one or more from a set of: a speed and a distance of a detected vehicle at an upcoming intersection, a braking capability of the driver's vehicle, and a braking capability of the detected vehicle.

15. The system of claim 11, wherein the information management framework is configured to analyze the received information in order to determine a need for the driver to perform at least one from a set of: turning off engine in response to an expected prolonged red light, turning on the engine at a predefined time prior to traffic signal turning green, reducing vehicle speed in anticipation of an upcoming red light, reducing the vehicle speed in anticipation of a pedestrian crossing an upcoming red light, reducing the vehicle speed in anticipation of another vehicle potentially running an upcoming red light, and selecting an alternate route in response to a fuel economy and road hazard analysis of potential routes.

16. The system of claim 11, wherein the signaling status and traffic timing information are received from a network of traffic light sensors and controllers, and the intersection status information is received from a network of intersection sensors comprising one or more of the following: optical sensors, in-road loop antenna sensors, laser based sensors, and radar based sensors.

17. A computer-readable storage medium having instructions stored thereon for causing a computing device to perform actions, the actions comprising:
receiving traffic related data collected from at least one data source application associated with a plurality of sensors at traffic signaling locations;
receiving a start location and a destination location for a vehicle from an on-vehicle technology;
determining a relevant portion of the data for the on-vehicle technology;
analyzing the relevant portion of the data, wherein the analysis includes filtering and interpretation of the data to determine a significance of the relevant portion of the data for the vehicle; and
transmitting the analyzed data to the on-vehicle technology through a wireless medium such that the on-vehicle technology is enabled to perform tasks comprising at least one from a set of: adjusting a fuel efficiency related vehicle operating parameter automatically, providing an alert to a driver of the vehicle regarding an adjustment of the fuel efficiency related vehicle operating parameter, providing an alert to the driver of the vehicle regarding a potential road hazard at an upcoming intersection, and providing a suggested alternate route between the start and destination locations based on at least one of fuel economy computation and road hazard computation.

18. The computer-readable storage medium of claim 17, wherein the on-vehicle technology is enabled to perform the tasks based on one or more of the following: receiving the analyzed data and receiving instructions in addition to the analyzed data.

19. The computer-readable storage medium of claim 17, wherein the at least one data source application is part of a municipality managed system communicating with one or more third party hosted platforms for facilitating dissemination of the traffic related data to subscribing on-vehicle technologies.

20. The computer-readable storage medium of claim 17, wherein the one or more third party hosted platforms are further configured to provide additional data to the subscribing on-vehicle technologies including at least one from a set of: mapping data, traffic conditions data, and weather conditions data.
